(19) United States
(12) Patent Application Publication
(10) Pub. No.: US 2021/0277340 A1
(43) Pub. Date: Sep. 9, 2021

(54) PROCESS FOR WINE-MAKING FROM CLARIFIED JUICE

(71) Applicant: BIOMCO, Albas (FR)

(72) Inventor: Benoit Beauvillain, Albas (FR)

(73) Assignee: BIOMCO, ALBAS (FR)

(21) Appl. No.: 16/482,884

(22) PCT Filed: Feb. 5, 2018
(86) PCT No.: PCT/FR2018/050278

§ 371 Date: Aug. 1, 2019

(30) Foreign Application Priority Data
Feb. 3, 2017 (FR) 17 50915

(51) Int. Cl. C12G 1/022; C12G 1/04; C12H 1/07

(52) U.S. Cl. CPC C12G 1/0203; C12H 1/063; C12G 1/04

(57) ABSTRACT

A winemaking method comprising in the following order: A step of harvesting the grapes; A step of stripping; A step of pressing; A step of separating the must and the pomace; A step of setting aside the pomace under inert atmosphere in a first container; A step of clarifying the must into a second container; A step of recombining the pomace and the clarified must in a single container; A step of fermenting.

The present invention relates to a winemaking method. In particular, the present invention relates to a new method with which to obtain a wine with more refined gustatory qualities and flavors than wines obtained by conventional winemaking methods.

The transformation of grape juice into wine has been known since antiquity. The Egyptians were the first to represent the steps of grape harvesting, crushing the grape berries and then using large terra-cotta jars for fermenting the beverage.

The methods currently used for making red wines repeat these major steps. After the grape harvest, the grapes are sorted and separated from the stalks or pieces of stalk and other foreign matter (this is the stripping or destemming step) and are then generally pressed (or crushed) before being placed in a tank. The pomace cap, composed of solid particles (primarily grape skins), forms on the surface and is routinely re-submerged to remain in contact with the must (liquid part); alcoholic fermentation occurs during this step where the sugars in the must are transformed into alcohol and the wine acquires its flavors, gustatory qualities and color. The pomace is then separated from the juice. There then remains in the juice more or less solid particles called must solids which have to be removed because these residues, mostly organic, have a harmful effect on the quality of the wine and do not provide any advantage. At this stage the must solids are also mixed with lees, fine particles mainly made up of dead fermentation yeasts. The elements making up the lees are hydrolyzed into smaller sized and more soluble elements; they give qualities to the wine: fullness, roundness and improve the liveliness and flavors. The step of clarifying the must is necessary in order to preserve the quality of the wine by avoiding leaving the organic material to break down there. This step however can only be done once the pomace is removed. During the operation of removing the must solids in conventional winemaking for red wine, the lees are unfortunately also eliminated because they are not separated from the must solids. After this step, called clarifying or racking, the wine then undergoes a step of malolactic fermentation which involves the transformation of malic acid into lactic acid. This step serves to reduce the acidity of the wine and to naturally stabilize it.

Traditionally these steps are commonly used in the production of all red wines all over the world and prove fully satisfactory. All the same, there is a continuing need to improve the gustatory qualities and the quality of the flavors of the wines.

For white wines, lighter than red wines, the pomace is removed at the beginning of the method and before placement in the tank. Freed of the pomace the must can then be clarified directly which allows the alcoholic fermentation to proceed without the must solids, and the lees can then be retained to give the wine a greater roundness in the mouth and improve its gustatory qualities. This is the case of some white wines described as “matured on lees.”

Since it is not possible to clarify a juice which still contains the pomace, red wines cannot at this time benefit from the advantages of an early clarifying before alcoholic fermentation.

To improve the winemaking and the quality of the wine produced, the object of the present invention is a winemaking method which comprises in the following order:

E1—A step of harvesting the grapes;

E2—A step of stripping;

E3—A step of pressing;

E4—A step of separating the must and the pomace;

E5—A step of setting aside the pomace under inert atmosphere in a first container (C1);

E6—A step of clarifying the must into a second container (C2);

E7—A step of recombining the pomace and the clarified must in a single container;

E8—A step of fermenting.

The present inventor observed that with protection of the pomace under inert atmosphere in a first container, the must could be clarified separately before reintroduction onto the pomace for fermentation. Further, the inventor observed that by protecting the pomace from oxidation with the inert atmosphere, it can be returned into contact with the must without losing its properties nor altering the quality of the winemaking method. When it is exposed to open air, the pomace deteriorates and loses its capacity to contribute flavor and body to the wine during fermentation. Traditionally, once the pomace is separated from the must, it is considered to be a waste and its handling makes it no longer fit to be immersed in the liquid.

In a preferred embodiment of the method according to the invention, a step of sulfiting and sowing of clarification enzymes is added during steps E1 and/or E2.

The inventor observed that it was advantageous to proceed with an early addition of enzymes and sulfur in order to perform a quick clarifying.

In a specific embodiment, the containers are tanks.

In the present, we understand tank to mean any sealed container suitable to contain a liquid. Containers traditionally used in the viticulture world may in particular be used, such as, for example, barrels, hogsheads, vats, muids or half-muid. Stainless steel tanks in particular have a good seal suited to the good implementation of the invention.

According to a specific embodiment, the container for step E7 can be the first or second tank or a third tank different from the first two.

In a preferred embodiment, in step E5 the pomace is inerted in a first tank (C1) and step E7 is done by adding the must into the first tank (C1).

The inventor remarked that it was preferable to limit the handling of the pomace and thus to recombine the pomace and the must by adding the must into the tank inside of which the pomace is inerted.

In a preferred embodiment, the tanks are each provided with a tight closing cover.

Because of this tight closure, the pomace and also the must can be protected from oxidation by tightly closing these tanks. Advantageously, the tight seal comprises a safety valve in case of an unexpected start of fermentation.

In a specific embodiment of the invention, the pomace and the must are put in the tank C1 and C2 directly after separation thereof and the air in the tanks is replaced by an inert gas.

The advantage of separating the pomace and the must by immediately placing them in two different containers allows avoiding any handling of the pomace which could lead to its breakdown. The pomace is then preserved by replacing the oxygen from the air contained in the tank with an inert gas.

Preferably, the step of setting aside the pomace is done under an atmosphere inerted using a mixture of 80% argon and 20% carbon dioxide.

The inventor observed that this mixture allowed a particularly effective protection of the pomace against oxidation.

In a specific embodiment, the steps E3 to E6 are done at a temperature included between 0 and 10° C.

Working at low temperature from the beginning of the harvest, and more specifically between the steps of pressing and clarifying serves to avoid the phenomena of breakdown and alteration of the qualities of the future beverage. Oxidation is in particular less active at low temperature. Further, a temperature included between 0 and 10° C. prevents any spontaneous start of fermentation unwanted at this stage.

Preferably, the method according to the invention comprises a step of assembling various grape varieties between step E7 and E8.

The inventor was able to observe that the assembly of various grape varieties done after each variety went through the steps E1 to E6 of the present method made it possible to combine the specific qualities and properties of each variety.

Advantageously, the method according to the invention further comprises an additional step E9 of maturing on the lees.

The lees are composed of yeasts coming from the alcoholic fermentation and sometimes also bacteria if the wine undergoes malolactic fermentation. These microorganisms experience a breakdown by autolysis. By breaking down, the lees release aromatic compounds and also molecules which improve the mouthfeel of the wine. The inventor observed that the addition of this step, unexpected for red wines, considerably improved the quality and stability of the wine.

Further, the inventor discovered that the method, subject of the present invention, could also be applied to winemaking for white wines by allowing the fermentation to occur at least in part in the presence of the pomace and to thus get a wine with a greater aromatic richness. Since the flavor precursors are mostly located in the skin, therefore in the pomace, fermenting the clarified white grape juice with the skin thereof has the advantage of considerably increasing the aromatic intensity and richness of the wine.

Other aspects, goals and advantages of the invention will appear upon reading the following description of an embodiment of the invention, given as a nonlimiting example. The invention will also be better understood in light of the attached drawings in which:

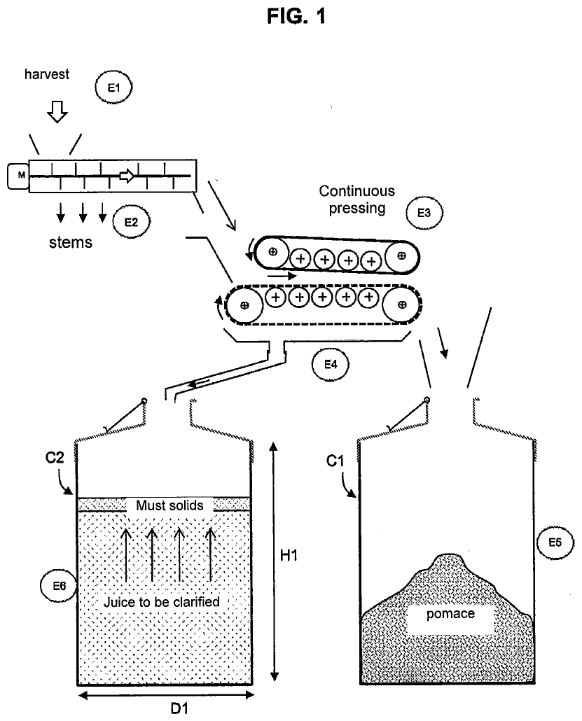

FIG. 1 shows the first part of a method according to the invention (steps E1 to E5).

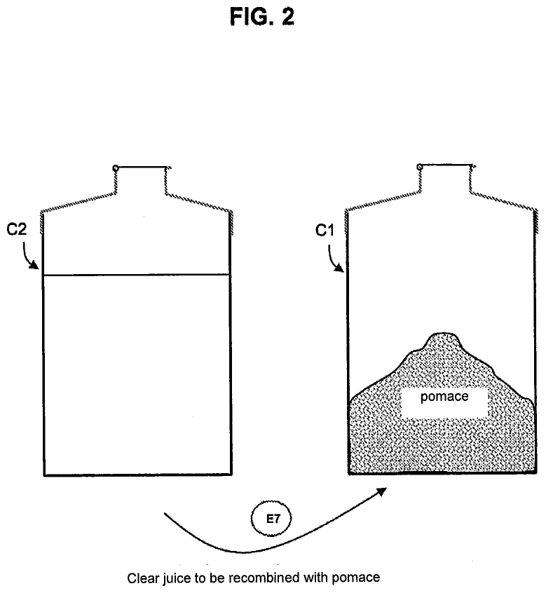

FIG. 2 shows the second part of a method according to the invention (steps E6 and E7).

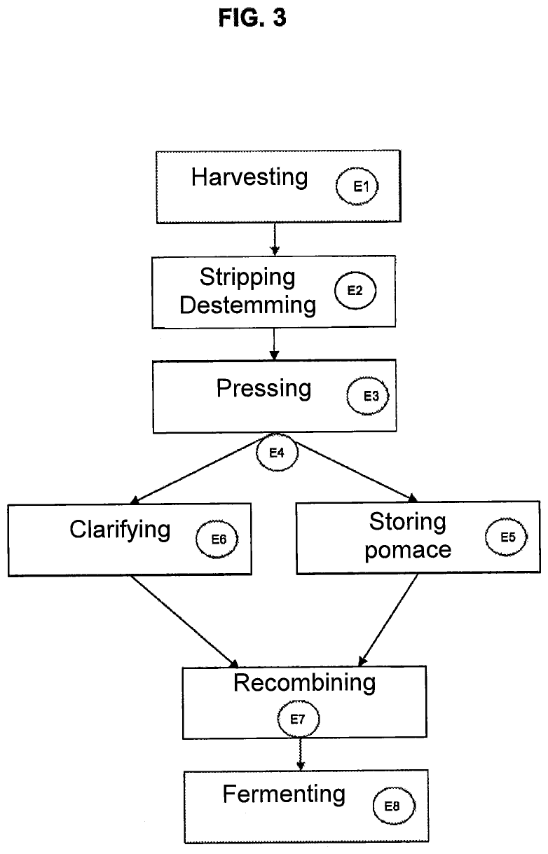

FIG. 3 shows the various steps of a method according to the present invention.

In the following, a specific embodiment of the present invention is described in detail.

The winemaking method from the present example comprises several successive steps.

First, a step of harvesting the grapes E1. This step is followed by a step of sulfiting and sowing of clarification enzymes. The grape, yeast or microbial flora are not naturally completely without these enzymes. Supplying exogenous enzymes is in general justified by the weak activity levels naturally encountered in grapes or yeasts. The natural winemaking phenomena can be accelerated and optimized with this addition.

It is next necessary to detach the grape berries from the stalks. The stripping E2 or destemming, consists, during or right after the harvest, of removing the stalks or peduncles from the bunch of grapes for retaining only the grape berries. In fact the presence of stalks could contribute herbaceous, vegetable, astringent and bitter tastes to the wine.

The stripping is done mechanically by using a stalk separator. It is done at a slow rate in order to avoid crushing the bunches of grapes or breaking the stalks which could release sap with the berries. A more selective sorting can then be considered in order to eliminate the remainder of the foreign matter, such as vegetable debris. Traditionally the sorting is done by means of a sorting table.

Next, a pressing step E3 occurs which allows the separation of the must and the pomace. The berries are crushed and the juice that they contain is separated from the solid parts (skin and seeds). In the example shown, a continuous pressing device is used composed of an upper conveyor belt and a lower rolling perforated belt, the working space which separates them decreases on moving in the forward direction, which causes the intended pressing and the passage of the juice through openings in the perforated belt.

At the end of this pressing step, the pomace (solid part) and the must (liquid part) are separated E4. The pomace spills into a first-tank C1 whereas the must is routed to a second tank C2.

The two tanks have a capacity suited to receive the juice (must) and the pomace. They comprise a bottom in their lower part, extended by a circular wall and end in their upper part with a bottleneck provided with a tight cover. In the example shown, cylindrical tanks are illustrated having for example a diameter D1 included between 1 m and 4 m and a height H1 included between 2 m and 5 m.

These tanks may however have various shapes and be made in any other type serial typically used in winemaking methods such as for example: concrete tanks, barrels, hogsheads, vats, muids or half-muid.

The oxygen in them can then be replaced by a mixture of 80% argon and 20% carbon dioxide; this mixture is heavier than air. This handling is known as such in the winemaking field and therefore it is not described in detail here. Thus, the pomace is inerted and preserved from oxidation (step E5), just like the must. Other gases or mixtures of gases can be considered in order to deprive the tanks of oxygen and prevent the oxidation of their content. The inert gas, heavier than air, is going to fill the tank starting from the bottom whereas at the same time, the lighter air is displaced from the top of the tank. Advantageously, tanks equipped with a tight closing cover which can then be reclosed are used here. Advantageously, this cover will be provided with a safety valve.

In particular, the inert gas coming from other tanks in fermentation can be recovered by a bridging system.

Two tanks in hermetically closed position are shown in FIG. 2.

The step of clarifying the must E6 can then commence. The clarifying is done by floating, preferably while sending a pressurized gas (generally CO2) and a binder (ideally gelatin) in the must. This gas can be added by an opening with selective closure arranged in the lower part of the tank. The gas can also be sent through a tube inserted by the top of the tank and opening out in the bottom of the tank. This mixture carries along the must solids and takes them to the surface. The liquid can also be clarified by cold settling, possibly with the help of enzymes. In this case, after extraction of the juice, pectins, coming from the grape berries and negatively charged, form a protective layer around positively charged solid particles, which keeps them in suspension. The action of breaking down these pectins by a specific enzyme, pectinase, serves to expose positive charges on these complexes which flocculate with the pectins to form larger size particles. When these particles reach a certain size, they settle and can be eliminated by racking.

Clarifying the liquid by filtration can also be considered. The step of recombining E7 the pomace and the clarified must in the first tank C1 occurs.

It is simpler to limit the handling of the pomace because it is fragile and breaks down very quickly. The clarified juice, also called clear juice, is gathered from the second tank C2 by racking in order to be returned to contact with the pomace. Alternatively, the pomace can be added into the second tank C2 or the juice and the pomace can both be gathered in a third tank.

It is preferably at this step that the assembly of the various grape varieties can be done.

Finally, a fermentation step E8 finishes off the winemaking method. Fermentation is the natural chemical process during which sugar from the great is transformed into alcohol under the action of the yeasts. Compounds that are higher alcohols, fatty acid esters, or even aldehydes are synthesized by the yeast in parallel to the transformation of the sugars into alcohol. Good progress of the winemaking involves an optimal development of the yeasts.

The fermentation can optionally be considered with a malolactic fermentation which corresponds to the transformation of malic acid into lactic acid via anaerobic bacteria called lactic bacteria. This step leads to a reduction in the acidity. It also allows a stabilization but even a softening of the wine. It can be done early, meaning at the same time as the alcoholic fermentation, or late in the months which follow, meaning during the maturing. It can be done in tank, or in a vat or keg.

The lees are composed of yeasts coming from the alcoholic fermentation and sometimes also bacteria if the wine undergoes malolactic fermentation. The maturing of the wine on fine lees can then be considered, preferably, before the malolactic fermentation because the yeast lees are finer than the bacterial lees. This is a practice which improves the quality and stability of the wine.

These microorganisms experience a breakdown by autolysis. This autolysis can be enhanced and accelerated by addition of enzymes such as beta-glucosidases. By breaking down, the lees release aromatic compounds and also molecules which improve the mouthfeel such as polysaccharides. Wines after maturing on lees have a more intense bouquet and also a more unctuous flavor.

Also, the natural stabilization at the chemical level is accentuated. The appearance of tartrate crystals (potassium bitartrate) in the bottom of the bottle also becomes rarer. The stability of the wines against tartrate precipitation is increased because of this maturing on the lees.

This maturing on fine lees is not, at present, possible in red wine except by using the present invention.

The steps E1 to E6 are particularly sensitive and will preferably be done at a temperature included between 0 and 10° C. As previously seen, this low temperature in particular provides protection from oxidation and blocks any unwanted spontaneous start of fermentation at this stage.

A thermovinification method can also be advantageously inserted at step E7 by heating the clarified juice at the time of the reincorporation of the juice in the pomace in the case of liquid phase thermovinification.

This technique consists of heating the grape varieties to 60-80° C. for a fairly short time of 6 to 18 hours and then quickly cooling to around 20° C. Thermovinification applied to this method gives even finer and fruitier wines than in a conventional method.

1. A winemaking method characterized in that it comprises in the following order:
E1—A step of harvesting the grapes;
E2—A step of stripping;
E3—A step of pressing;
E4—A step of separating the must and the pomace;
E5—A step of setting aside the pomace under inert atmosphere in a first container;
E6—A step of clarifying the must into a second container;
E7—A step of recombining the pomace and the clarified must in a single container;
E8—A step of fermenting.

2. The method according to claim 1 comprising a step of sulfiting and sowing of clarification enzymes during steps E1 and/or E2.

3. The method according to claim 1 wherein the first and second containers are tanks.

4. The method according to claim 1 wherein the container for step E7 can be the first or second tank (C1, C2) or a third tank different from the first two.

5. The method according to claim 3 wherein in step E5 the pomace is inerted in a first tank and wherein step E7 is done by adding the must into the first tank.

6. The method according to claim 3 wherein the tanks are each provided with a tight closing cover.

7. The method according to claim 1 wherein the pomace and the must are respectively put in the first and second tanks (C1, C2) directly after separation thereof and the air in the tanks is replaced by an inert gas.

8. The method according to claim 1 wherein the step of setting aside the pomace is done under an atmosphere inerted using a mixture of 80% argon and 20% carbon dioxide.

9. The method according to claim 1 wherein the steps E3 to E6 are done at a temperature included between 0 and 10° C.

10. The method according to claim 1 comprising a step of assembling various grape varieties between step E7 and E8.

11. The method according to claim 1 further comprising an additional step E9 of maturing on the lees.
